(19) United States
(12) Patent Application Publication
(10) Pub. No.: US 2012/0330358 A1
(43) Pub. Date: Dec. 27, 2012

(54) PACIFIER HOLDER

(76) Inventor: Thresia Gladys Ahern, Humpty Doo (AU)

(21) Appl. No.: 13/531,564

(22) Filed: Jun. 24, 2012

(30) Foreign Application Priority Data
Jun. 25, 2011 (AU) 2011902508

(51) Int. Cl. A61J 17/00

(52) U.S. Cl. 606/234

(57) ABSTRACT

A pacifier holder comprising a shaft; a cover moveably connected to the shaft; a base attached to the shaft at a lower aspect of the shaft; so constructed and arranged that the cover can slide downwards along the shaft under action of gravity to cover a pacifier located on the base.

### PRIORITY CLAIM

This application claims priority under 35 USC 119(a)-(d) or (f) or 365(b) or any other relevant section of USC and corresponding regulations, to Australian Patent Application No. 2011902508 titled “Pacifier Holder” of Thresia Gladys Ahern filed on Jun. 25, 2011, which is hereby incorporated by reference as though fully set forth herein.

### BACKGROUND OF INVENTION

1. Technical Field

The present invention relates to the field of infant pacifier holders.

2. Background Art

Pacifiers, including ‘dummies’ are often the subjects of the spread of potentially lethal disease. Infants and young children routinely spit a pacifier out of their mouth, the pacifier will then land on the ground where the pacifier can be subject to contamination. Carers of young children go to great efforts to clean pacifiers in an attempt to inhibit the spread of disease. Pacifier holders have, in some cases, been equipped with removable manually operated covers to prevent the spread of disease.

### SUMMARY OF INVENTION

### Technical Problem

Technical problem: to produce a self closing pacifier holder that is (i) safe, in particular that avoids risks of choking (ii) low in cost to manufacture and (iii) avoids unnecessary contact with a child's face—hygienic in nature.

Central to the present invention is the recognition of the problem by the inventor, that although some pacifier holders have covers to inhibit the spread of disease, that the covers of some prior art pacifier holders require manual operation (attachment) to protect the pacifier housed within the cover. This means, in use, that pacifiers are routinely exposed to the external environment and also to handling by other children prior to being recovered and cleaned by a carer. Further, central to the inventor's discovery is the realization that the problem with many of the existing pacifier holders is that they do not, for the most part, close automatically when ejected from a child's mouth and that even those pacifier holders that could be argued to be self-closing, at least to some extent, have other defects including a plurality of moving parts (excess complexity) that creates choking hazards if the pacifier holder separates after extended use.

### Technical Solution

Technical solution: producing a self closing pacifier holder that has (i) a minimum of moving parts and in one embodiment can have no moving parts if integrally formed of elastic material and so avoids the risks of choking if the pacifier holder separates into a plurality of pieces (ii) avoids the use of springs and pivots in one embodiment by using simple gravity to close the pacifier holder and so is low in cost to make and safe to use (iii) has a cover that remains clear of a child's face and in particular the child's cheeks when in use and so minimizes disease transmission to the user (the child).

### Advantageous Effects

Advantageous effects include:

Minimizing the prospect of transmission of disease to a child using a pacifier on a pacifier holder (the pacifier cover not otherwise coming into operation automatically upon ejection of the pacifier from a baby's mouth, in contrast to the present invention).

In a first aspect of invention, a pacifier holder comprising:

a shaft;
a cover moveably connected to the shaft;
a base attached to the shaft at a lower aspect of the shaft;
so constructed and arranged that the cover can slide downwards along the shaft under action of gravity to cover a pacifier located on the base.

In another feature of the first aspect of invention, the cover has an upper aperture and a lower aperture, the upper aperture snugly fitted around the shaft, so constructed and arranged that the cover can slide down and along the shaft under action of gravity to cover the pacifier.

In a second aspect of invention, an integrally formed pacifier holder comprising:

a shaft;
a cover moveably connected to the shaft;
a base attached to the shaft at a lower aspect of the shaft;
the holder so constructed and arranged of elastic material that the cover can slide downwards along the shaft to cover a pacifier located on the base.

In a third aspect of invention, an integrally formed pacifier holder comprising:

a cover;
an elongated elastic member connected to an inside aspect of the cover;
a base located at a lower aspect of the elongated member, the base being connected to a pacifier;
the elongated elastic member so constructed and arranged that the pacifier can extend out from under the cover and when the pacifier is released, the pacifier can then withdraw under the cover.

### BRIEF DESCRIPTION OF DRAWINGS

FIG. 1 discloses a mode of invention for use with a bell shaped cover.

FIG. 2 discloses the pacifier holder depicted in FIG. 1 in closed position.

FIG. 3 discloses a pacifier holder with a cover that provides complete closure.

FIG. 4 discloses a pacifier holder having a protrusion (nodule) that is adapted to lock the cover in an open position.

FIG. 5 discloses covers having different novelty forms that are designed to encourage children to use the present invention.

FIG. 6 discloses a pacifier holder having a cover in the form of a cup that slides down a track in the holder under the influence of gravity.

FIG. 7 discloses a pacifier holder in use by a baby.

FIG. 8 discloses a pacifier holder having an extensible shaft.

FIG. 9(A) and FIG. 9(B) disclose a pacifier holder having an elongated member taking the form of an extensible cord.

FIG. 9(C) discloses a pacifier holder in which the elongated member seen as a shaft in FIG. 1 is a flexible cord.

### DETAILED DESCRIPTION

### Best Mode

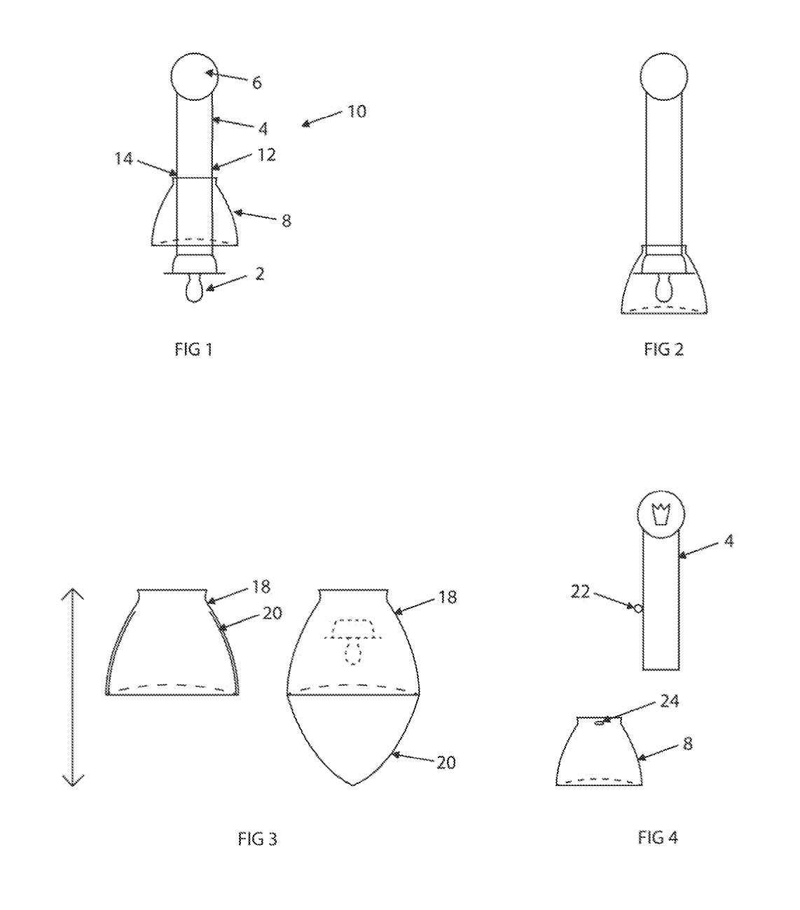

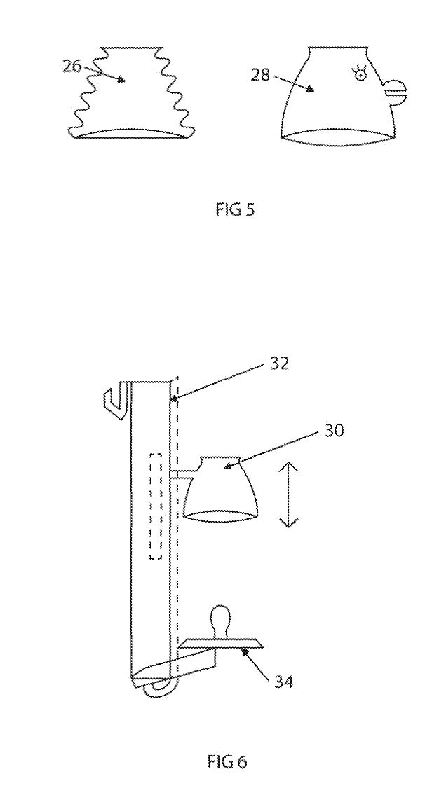

FIG. 1 discloses a pacifier holder in frontal elevation view. At the apex of the holder is a ring 6 (that can also take the form of a clip). The ring can be used to secure the pacifier holder directly to clothing of a child or indirectly by way of an attachment harness (not shown). The pacifier holder has an elongated member 4, taking the form, in this particular embodiment, of a shaft (although the shaft could be replaced by a plurality of objects including flexible members and even a cord in other embodiments). Located over the shaft 4 is a cover 8 in the form of a bell. The cover 8 has an upper aperture that is sufficiently small to snugly fit around the shaft 4 (yet sufficiently large so as to permit the cover 8 to move downward over the shaft 4). The cover 8 has a lower aperture that is sufficiently large to cover the pacifier 2. The shaft 4 also has a retention mechanism 14 that can be used to secure the cover 8 to the shaft 4. When the cover 8 is not forcibly secured against the retention mechanism 14 (seen in side view in FIG. 4 as a protrusion (nodule)), the cover 8 is free to move between the retention mechanism 14 and the lower end of the shaft 4. In the downward position shown in FIG. 1, the cover 8 will slide down on the shaft 4 to protect the pacifier 2 against contamination (see FIG. 2).

FIG. 2 shows the cover 8 in a position so as to cover the pacifier 2 after having fallen downwards as a result of the action of gravity. However, gravity alone need not be the only force used to secure the cover 8 over the pacifier 2. Additional forms of obtaining coverage of the pacifier 2 can be envisaged including the use of elastic devises. The elastic devises (not shown) can include springs. Further, to the above, actuators powered by batteries can be used to secure the cover 8 over the pacifier 2. Additionally, motion sensors can be incorporated to actuate the cover 8 based upon the spatial orientation of the cover and also upon the proximity of a child's mouth to the pacifier holder 10.

FIG. 3 shows an embodiment of the cover 8 (first seen in FIG. 1) now taking the form of an outer cover 18 and an inner cover 20. The inner cover 20 will typically be constructed in the form of a plurality of sections. The inner cover 20 can telescope downwards, along the inside surface of the outer cover 18, so as to completely enclose the pacifier 2. The telescopic construction shown in FIG. 3 need not be restricted to a cover having the shape of a bell. Alternative embodiments can be envisaged in which the outer cover 18 and the inner cover 20 can be substantially cylindrical in shape so as to enable the inner cover 20 to be formed in one piece. Telescopic extension will increase coverage of the pacifier 2 by the covers 18 and 20.

FIG. 4 shows components of the pacifier holder first seen in FIG. 1 but now appearing in disassembled form (to aid cleaning and sanitising). The shaft 4 depicts the retention mechanism 14 (first seen in FIG. 1) now shown as a protrusion (nodule) 22, which can be force fitted into the cover 8, thereby locking into place in an aperture 24 located in cover 8. The protrusion 22 can also take the form of a spring-loaded button.

FIG. 5 shows a plurality of different embodiments of cover 8. The different forms of the cover 8 are illustrated in the form of a shell 26 and a chicken 28. Covers having different playful forms encourage children to be receptive to the use of a pacifier holder that includes a cover 8.

In addition to the embodiments shown in the figures, additional embodiments can be envisaged in which an outer portion of the shaft 4 can extend over the pacifier 2 (negating the need for a visually distinct and separate cover). Additionally, construction in reverse format can be envisaged, in which the pacifier 2 (under the control of a motion sensor) will only extend out from the shaft 4 when the child's mouth is in close proximity to the end of the shaft 4. Further, embodiments can be envisaged in which a holder is, at least in part, formed of elastic material so as to enable a child to use a pacifier fixed into the holder by squeezing the pacifier (the pacifier then retracting under the cover of the pacifier holder by way of elasticity when the child ejects the pacifier from his\her mouth).

FIG. 6 shows a preferred embodiment of the holder in which the cover takes the form of a cup 30. The cup 30 is located in a track that runs within shaft 32 (tracks can be formed in shaft 32 by hollowing out the shaft, at least in part). The cup 30, when held in the vertical position as shown in FIG. 6, will slide downwards to cover the pacifier. When in use, the base (seen as a lip) 34 of the pacifier holder, can be elastically and pivotally attached to the shaft 32 in such a manner as to enable the lip 34 to clear the shaft 32 and the cup 30 for use by a child in an unimpeded manner. Similarly, when the pacifier is not in use, then as recited above, the cup 30 will fall down and over the pacifier for secure location upon the lip 34. Further, the cup 30 can be made of sufficiently soft material so as not to irritate a child when in use.

### Mode for Invention

One preferred mode of invention of a pacifier holder, in general form, envisages a pacifier holder comprising:

a shaft;
a cover in shape of a cup located on a track in the shaft;
a base in shape of a lip, for connection to the pacifier, the base located at a lower aspect of the shaft;
so constructed and arranged that the cover will run downwards along the shaft in the track so as to cover the pacifier when the pacifier is ejected from a user's mouth.

As recited above, while the drawings depict pacifiers of purely mechanical construction it can be envisaged that battery operated motion sensors can be used to close a cover over the pacifier or alternatively to retract the pacifier within a closed region of the pacifier holder (retraction can also occur by other means including elasticity of the holder). Further, as recited above, in a more general embodiment, while the pacifier has been depicted with a shaft to hold the cover it can be envisaged that the shaft need not be rigid in construction but can even take the form of a flexible elongated member provided that the member, including a fastening cord, is so constructed and arranged to permit the cover to slide down over the pacifier.

In a further aspect of invention, a portion of the pacifier holder's elongate member, could itself comprise the cover.

In another aspect of invention, the pacifier holder as the elongate member, could surround over the top of the cover.

In another aspect of invention, the pacifier holder with an integrated cover could be made in one piece, which could all be sanitised as one piece. Alternatively, embodiments can be envisaged in which at least one and potentially all members of the holder can be mutually separated so as to facilitate cleaning and sanitization (provided that the holder is so constructed and arranged so as not to separate when in use by a child).

In another aspect of invention, the combined pacifier, cover and elongate member and base could all be incorporated into clothing, belts and any other item that a child wears; the holder can also be incorporated into baby furniture including high chairs, car seats, prams and bouncers.

In another aspect of invention, the top portion of the holder's shaft can be made to retract into its self so as to prevent a pacifier dragging along the ground when a baby is crawling. Alternatively, the holder can be made with an incorporated retracting cord. Alternatively, the top of the shaft can be made of elastic material so as to withdraw the pacifier away from the ground when the baby is crawling.

In a further aspect of invention, a pacifier holder can be incorporated into baby furniture as recited above.

In a further aspect of invention, a pacifier holder can be made with its own pacifier included on the shaft or with the pacifier provided separately as an accessory.

### INDUSTRIAL APPLICABILITY

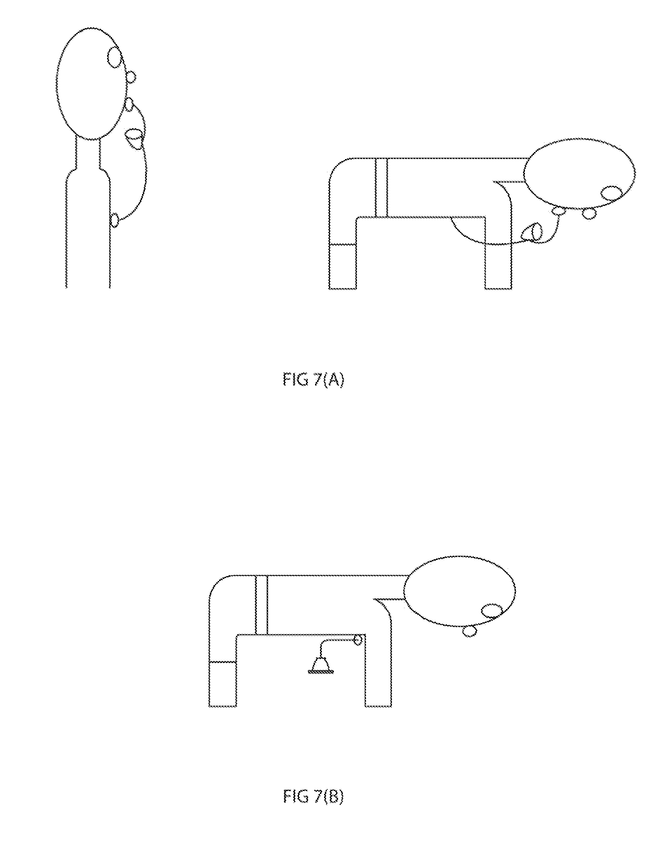

FIG. 7 shows the pacifier holder in use on a baby. In FIG. 7(A) the pacifier is located in the baby's mouth. However, when the pacifier has been spat out of the baby's mouth as seen in FIG. 7(B) then the pacifier cover will fall down over the pacifier as the pacifier holder falls into a vertical position with respect to the ground. Retention of the pacifier holder in proximal location to the baby's body can be encouraged by the use of magnets and also by the use of a stiff fastening clip that is used to secure the pacifier to the baby's clothing.

In use, the pacifier can be integrated into the holder. Alternatively, in alternative embodiments the pacifier can be adapted for removal from the holder. The cover can also be enabled for removal from the holder to facilitate cleaning. In addition to removal of the cover, embodiments can be envisaged in which all moving parts, including the holder can be separated for cleaning and sanitizing prior to subsequently being reconnected together again in a safe manner (so as to preclude an infant gaining access to parts that could cause choking).

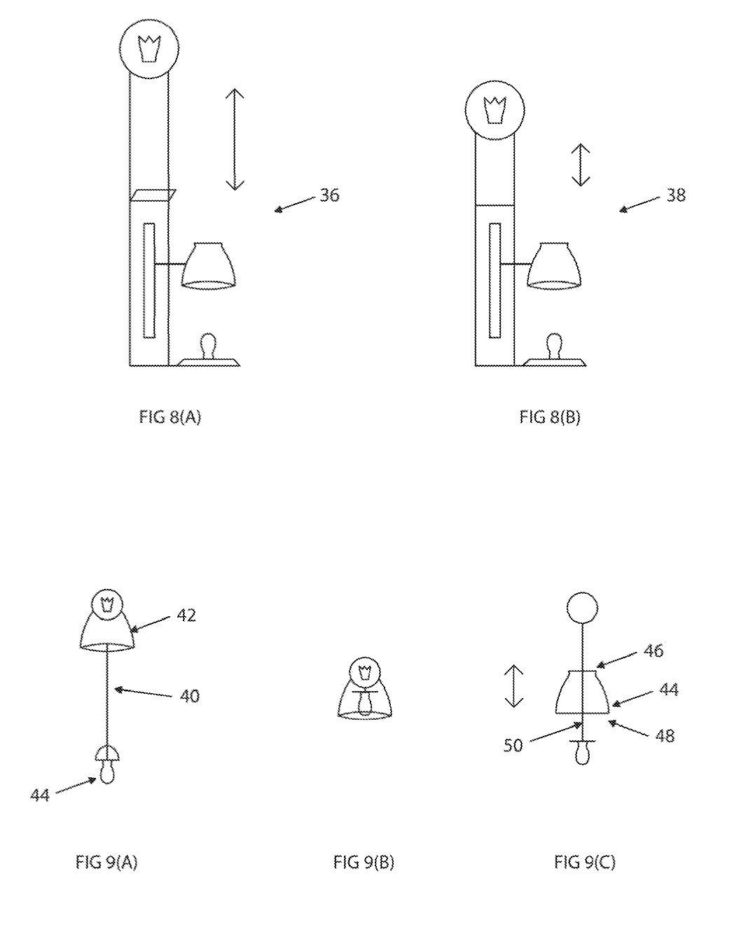

FIG. 8 discloses a further embodiment in which the elongated member is elastically extensible. As seen in FIG. 8(A) the elongated member has been extended with respect to the unextended position as seen in FIG. 8(B). In use, the elastic nature of the elongated member depicted in FIG. 8 enables the pacifier to clear the ground in the case of use by a crawling child (the pacifier holder can be fixed to the child's clothing), thereby minimizing the prospect of contamination of the pacifier.

FIG. 9 discloses another aspect of invention in which the elongated member takes the form of a cord 40. As seen in FIG. 9(A) and FIG. 9(B) the cord 40 being elastic, extends into and out of the cover 42. In contrast to embodiments seen at FIG. 9(A) and FIG. 9(B) in which the pacifier 44 moves relative to the cover 42, FIG. 9(C) depicts an embodiment in which the cover 44 has two apertures (one at the apex 46 and one at the base 48 of the cover 44). Accordingly, while the cord 50 as seen in FIG. 9(C) can be elastic it need not be as the cover 44 can move over the cord 44 to reversibly expose and cover the pacifier. In use, the elastic nature of the elongated member seen in FIG. 9(A) and FIG. 9(B) serves dual purposes of assisting in coverage of the pacifier 44 and also retracting the pacifier away from the ground when used by a crawling child.

In use, the cover can be made in various sizes to facilitate coverage of a plurality of pacifiers including teats and toys. The pacifier holder and associated cover can be fashioned in a plurality of sizes and dimensions to cover all or part only of the pacifier. Further, the pacifier holder can be fashioned, if necessary, by way of the inclusion of an elastic retention harnesses forming part of or an extension of the holder, so as to prevent the pacifier dragging on the ground when not in use by a baby.

Further, in general, protecting pacifiers from germs with non-self closing holders is extremely difficult, because the pacifier typically hangs on the end of a pacifier holder that can then bounce en tables, be coughed on or dragged and so contaminated with germs. A combination pacifier and pacifier holder that requires the carer to manually put the pacifier (that can be a teat) under the pacifier cover leaves the pacifier potentially exposed to germs until such time as the pacifier is secure under the cover. A pacifier holder that has a plurality of moving parts can be bulky; can be located close to or on the mouth of a user, hence exposing the user, typically a baby to contamination from the pacifier's cover if the cover touches the baby's face. Accordingly, the carer needs to supervise the child with the pacifier to prevent a choking accident in the event that the combined pacifier holder and pacifier break apart (a danger with any device having an unnecessary excess of moving parts). The present invention seeks, to remedy or at the very least ameliorate many of these problems associated with prior art pacifiers.

The present invention provides a solution to the above problems and enables the carer to choose their pacifier and to add it to the combined pacifier holder and cover. Further, according to the present invention, once the pacifier has been dislodged from the mouth of the user, the cover on the pacifier holder, via means that can include gravity, moves down to cover the pacifier, which can include a teat. Further, the present invention envisages embodiments in which the cover can be removed for cleaning and also reverse styled embodiments in which the pacifier can retract into the cover as opposed to the cover extending over the pacifier.

### NOTES AND RESERVATIONS

It should be noted that all of the invention or any component or combination of components of the invention can be formed in solid, hollow or frame-like form or mono or multi-component form from many different natural or synthetic materials, for example metal, including alloys and/or monolithic or composite plastics.

Different components of the invention may be formed from different materials in order to provide desired properties of strength, weight, rigidity and resiliency and in particular, concerning their ability to provide a safe product for babies and toddlers.

Although the invention has been described with reference to examples, it will be appreciated by those skilled in the art that the invention can be embodied in many other forms. For example, while the invention has been described for use in conjunction with a pacifier holder attached to a child it will be appreciated that the invention can equally be applied in other embodiments.

The invention can also be said broadly to consist in or of parts, elements and features as illustrated and or referred to in the description of the invention (either individually or collectively or in any or all combinations of parts or a plurality of said parts, elements or features).

Where specific integers are mentioned which have known equivalents in the art/s to which the invention relates, such known equivalents are deemed to be incorporated as if individually set forth.

Although preferred embodiments have been described in detail, it should be understood that various changes, substitutions and alterations could be made herein, by those of ordinary skills in the relevant art/s without departing from the spirit or scope of the present invention.

The inventor asserts her moral rights to be recognised as the creator and owner of this invention, design and the Intellectual Property associated with her invention.

1. A pacifier holder comprising:
a shaft;
a cover moveably connected to the shaft;
a base attached to the shaft at a lower aspect of the shaft;
so constructed and arranged that the cover can slide downwards along the shaft under action of gravity to cover a pacifier located on the base.

2. The pacifier holder as recited in claim 1 in which the cover is formed in shape of a cup.

3. The pacifier holder as recited in claim 2 in which the base is formed in shape of a lip.

4. The pacifier holder as recited in claim 3 in which the cover is connected to the shaft by a hollow track in the shaft.

5. The pacifier holder as recited in claim 4 in which the cover is integrally formed.

6. The pacifier holder as recited in claim 1 in which the cover has an upper aperture and a lower aperture, the upper aperture snugly fitted around the shaft, so constructed and arranged that the cover can slide down and along the shaft under action of gravity to cover the pacifier.

7. The pacifier holder as recited in claim 6 in which the cover includes an inner cover and an outer cover, so constructed and arranged that the cover can telescope downwards so as to provide complete protection for the pacifier.

8. The pacifier holder as recited in claim 7 in which the shaft has a retention mechanism; so constructed and arranged that the retention mechanism can lock the cover into place against the shaft.

9. The pacifier holder as recited in claim 8 in which the cover is shaped in the form of a novelty item so as to encourage use of the pacifier holder by children.

10. An integrally formed pacifier holder comprising:
a shaft;
a cover moveably connected to the shaft;
a base attached to the shaft at a lower aspect of the shaft;
the holder so constructed and arranged of elastic material that the cover can slide downwards along the shaft to cover a pacifier located on the base.

11. An integrally formed pacifier holder comprising:
a cover;
an elongated elastic member connected to an inside aspect of the cover;
a base located at a lower aspect of the elongated member, the base connected to a pacifier;
the elongated elastic member so constructed and arranged so that the pacifier can extend out from under the cover and when the pacifier is released, the pacifier can withdraw under the cover.
